(19) United States
(12) Patent Application Publication
(10) Pub. No.: US 2003/0056380 A1
(43) Pub. Date: Mar. 27, 2003

(54) Target

(76) Inventor: Arthur Fred Sigueiros, Watsonville, CA (US)

Correspondence Address: John B. Dickman, III, Suite 1203, 2001 Jefferson Davis Hyw., Arlington, VA, 22202, US

(21) Appl. No.: 09/962,400

(22) Filed: Sep. 26, 2001

(51) Int. Cl. G01C 15/06

(52) U.S. Cl. 33/293

(57) ABSTRACT

A surveying target device for creating a rise of fall of a swale for water flow. The surveying target device is a rectangular card with a surface having gradient lines for measuring grade rise or fall. A handle engaging portion that is integral with the rectangular card can be attached to a handle or pole by a clamping strip.

### BACKGROUND OF THE INVENTION

The present invention relates to the field of paving and creating a grade for water flow, and, in particular, to tool for “making grade.”

For years, grade was established by then practical methods, such as, while one person rakes a surface to create a fall for water to flow, another person followed with a level to advise if the fall or grade is correct. There are problems with this system, as for example, asphalt cools quickly therefore it is much more difficult for the raker to create a smooth surface. The more he goes over the asphalt surface the more likely there will be rock pockets, pockets where rocks are pulled from the asphalt. Other methods include the use of a stringline, sightlevel and laser.

The use of laser systems is recent and also represents a large investment for creating grade. Using a sight level requires staking the length of a swale, the area where water collects and moves down the grade, for reference points, and a person to shoot grade for a raker.

While each of the systems is functional, they each have their shortcomings in that they are either inaccurate or expensive. The present invention overcomes these shortcomings in that it is reliable and inexpensive.

### SUMMARY OF THE INVENTION

The invention is a very simple to use tool which when used with a laser speeds up the checking of grade. It is important to have proper grade for water run-off, therefore, a system, which includes the present invention that quickly and accurately establishes grade, is of major importance to concrete and asphalt contractors.

The tool of this invention is a target with gradient marks and a handle-engaging portion for attaching to the handle. The target portion is an opaque elongated plastic or metal piece where the gradient marks are of a highlighted color to stand out against the target portion background.

The handle-engaging portion is structurally shaped to conform to a handle, such as a rake used to move concrete. This handle-engaging portion has an arcuate cross-section that wraps part way around the handle. A strap extends around the handle to secure the target at a desired height on the handle.

### DESCRIPTION OF THE DRAWINGS

FIG. 1 shows a target device of the invention;

FIG. 2 shows a target device of the invention attached to a pole; and,

FIG. 3 shows a target device of the invention attached to a rake and a laser device for establishing a grade line.

### DESCRIPTION OF THE INVENTION

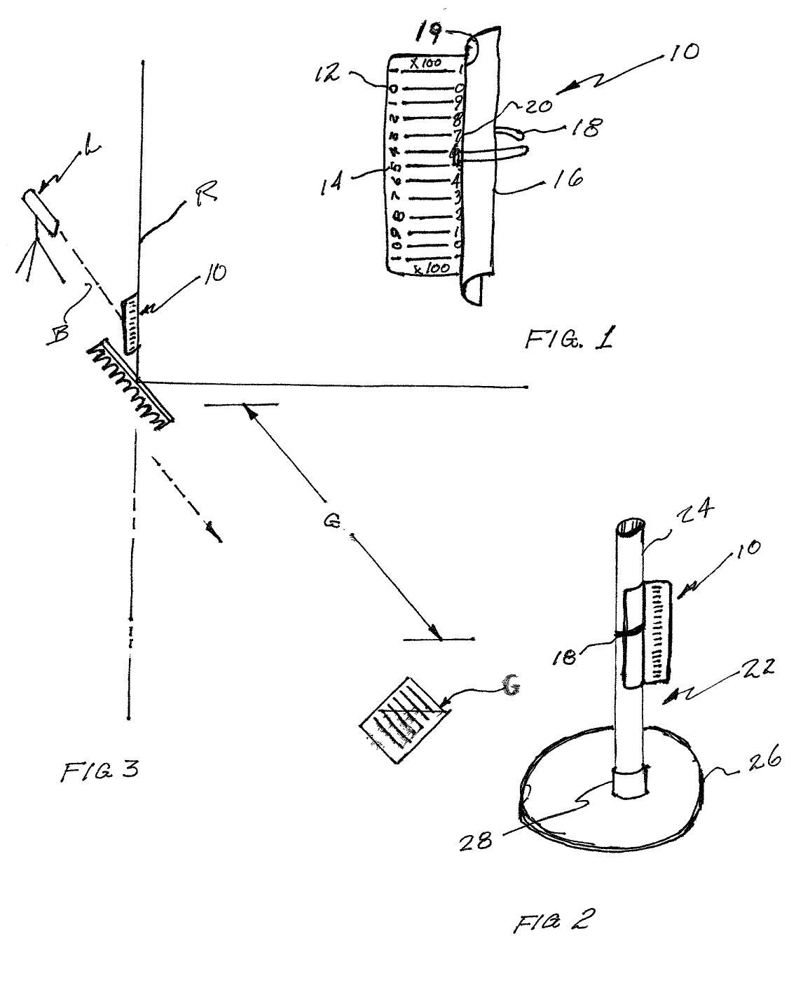

A preferred embodiment of the present invention is shown in FIG. 1. A target device 10 is shown having a rectangular shaped card 12 with gradient marks 14. The card 12 is made of a rigid plastic or metal to withstand the day to day use in construction. Gradient marks 14 are highlighted to standout against the card 12 background. When properly positioned in front of a laser, the target can be used to establish a finished grade using a level on the laser. The beam of light B from the laser marks a reference point, form which the target can be moved up or down the finish grade to establish a flow line.

In order to attach the target 10 to a handle, such as a rack, the target 10 has a handle-engaging portion 16, which is integral with edge 19. Handle-engaging portion 16 has an arcurate shaped cross-section to conform to the cylindrical handle. It is possible that the handle-engaging portion could have other cross-section shapes, as for example U shaped to conform to a shaft having a square cross-section. A strap 18 extends through a slot 20 in the target to wrap around a handle R or a post 24 in FIG. 2.

FIG. 2 shows a target 10 strapped to post assembly 22. The assembly 22 has a post 24 that is removably attached to a stand 26 with a post-receiving conduit 28.

In FIG. 3, the target device 10 is attached to a rake R and is positioned in front of a laser L. The grade flow line G is established to direct water to sewer grade G.

To use the target device 10, the torpedo laser L on a tripod is pointed in a straight line B in the direction of the swale to be pulled, keeping in mind not to block the laser L by pulling it in the path of the paver. The laser should line up the desired flow line. The target device 10 is attached to rake R and places the target device 10 along the sight line B of the finished grade at the end where the laser L is located. The rake is set at the desired height, lining the red laser dot on zero and clamping the target device 10 in place. Depending on whether the grade rises or falls determines if the zero is at the top or bottom of the gradient 14. Taking the target device 10 to the opposite end of the swale it can be determined how much fall there is to establish grade.

One of the problems in construction is getting water to flow correctly on nearly a flat surface. Therefore, in order to create a 1% fall, starting at the high, the target device is set at zero at the bottom of the gradient, and the concrete is raked to create a swale. At the five foot mark, the fall line is checked again where the laser dot should be at the 5 hundredths above zero. At ten feet, the red dot should be 10 hundredths, or 1 tenth for every 10 feet.

While only one embodiment of the target device has been disclosed, one should look to the drawings, disclosure and claims for a full understanding of the invention.

1. A surveying target device for use in making grade for water flow in a swale, including:
a rigid card structure having a rectangular shape with two surfaces and gradient lines;
a handle engaging portion integral with said rigid card structure, where said handle engaging portion is integral with one of the longer sides of the rectangular shaped card; and,
whereby said gradient lines are on said rigid card structure and are readable on said surface having equally spaced gradient lines numbered from 0 to 100.

2. A surveying target device as in claim 1 where said gradient lines are highlighted to standout from the background surface of said rigid card structures.

3. A surveying target device as in claim 2 wherein said handle engaging position has an arcuate shaped cross-section to conform to a rake handle, pole and the like.

4. A surveying target device as in claim 3 where a strap-like securing device secures said surveying target device to a rake handle, pole, and the like.

5. A surveying target device as in claim 4 where said gradient lines are numbered from zero to one hundred, starting from the bottom, and from zero to one hundred starting from the top.
